(19) United States
(12) Patent Application Publication
(10) Pub. No.: US 2025/0330732 A1
(43) Pub. Date: Oct. 23, 2025

(54) WIRELESS DATA TERMINAL

(71) Applicant: SPREADTRUM COMMUNICATIONS (SHANGHAI) CO., LTD., Shanghai (CN)

(72) Inventors: Fuyou TIAN, Shanghai (CN); Xiaofei YANG, Shanghai (CN); Si CHEN, Shanghai (CN); Xing WANG, Shanghai (CN); Lei SHEN, Shanghai (CN)

(21) Appl. No.: 18/873,223

(22) PCT Filed: Jun. 7, 2023
(86) PCT No.: PCT/CN2023/098986

§ 371 Date: Dec. 9, 2024

(30) Foreign Application Priority Data
Jun. 7, 2022 (CN) 202210639274.X

(51) Int. Cl. H04Q 1/04; H04Q 1/02

(52) U.S. Cl. CPC H04Q 1/04; H04Q 1/035

(57) ABSTRACT

The present disclosure relates to a wireless data terminal, including a first main body, which includes a mainboard, the mainboard being provided with a first antenna; and a second main body, which is provided with a second antenna; where the second antenna can be connected to the mainboard, at least the second antenna is used for receiving and transmitting a cellular signal and a WiFi signal; and the second antenna can be disconnected from the mainboard, the first antenna is used for receiving and transmitting a cellular signal and a WiFi signal.

### CROSS-REFERENCE TO RELATED APPLICATIONS

This application is a National Stage of International Application No. PCT/CN2023/098986, filed on Jun. 7, 2023, which claims priority to Chinese Patent Application No. 202210639274.X, entitled “WIRELESS DATA TERMINAL”, filed with the China National Intellectual Property Administration on Jun. 7, 2022, both of which are incorporated by reference herein.

### TECHNICAL FIELD

The present disclosure relates to the technical field of terminal device and, in particular, to a wireless data terminal.

### BACKGROUND

CPE (Consumer Premise Equipment) is generally used in homes and small office/business units, and can convert 3G/4G/5G cellular signals into broadband and WiFi signals, thus avoiding hassle of setting up a separate wired network. CPE is widely used in remote and scattered living areas, and even in 5G smart factories. CPE products are fixed in specific locations for use, with large volume and poor portability, which cannot meet the needs of users when they are out-of-home.

### SUMMARY

Embodiments of the present disclosure provide a wireless data terminal, including: a first main body, which includes a mainboard, the mainboard being provided with a first antenna: and a second main body, which is provided with a second antenna: where the second antenna is capable of being connected to the mainboard, at least the second antenna is used for receiving and transmitting a cellular signal and a WiFi signal: and the second antenna is capable of being disconnected from the mainboard, the first antenna is used for receiving and transmitting a cellular signal and a WiFi signal.

It should be understood that both the foregoing general description and the following detailed description are merely exemplary and do not limit the present disclosure.

### BRIEF DESCRIPTION OF DRAWINGS

FIG. 1 is a schematic structural diagram of a wireless data terminal in a specific embodiment according to the present disclosure, where a main board is connected with a second antenna.

FIG. 2 is a schematic structural diagram of a first main body in FIG. 1.

FIG. 3 is an exploded view of FIG. 2.

FIG. 4 is a schematic structural diagram of FIG. 2 in a first embodiment with a rear housing removed.

FIG. 5 is an exploded view of a second main body of FIG. 1.

FIG. 6 is a side view of the second main body of FIG. 1.

FIG. 7 is a perspective view of the second main body of FIG. 1.

FIG. 8 is a front view of the second main body of FIG. 1.

FIG. 9 is a sectional view taken along line A-A of FIG. 8 in a first specific embodiment.

FIG. 10 is a partially enlarged view of portion I in FIG. 9.

FIG. 11 is a bottom view of the second main body of FIG. 1.

FIG. 12 is a schematic structural diagram of a bottom housing with a second support member removed in FIG. 11.

FIG. 13 is a schematic structural diagram of a circuit board, a heat dissipation member, a cable, a first plug, a second plug and a foam in FIG. 5.

FIG. 14 is a sectional view taken along line A-A of FIG. 8 in a second specific embodiment.

FIG. 15 is a sectional view taken along line B-B of FIG. 14.

FIG. 16 is a schematic diagram of the structure of FIG. 2 in a second embodiment with a rear housing removed.

FIG. 17 is a schematic structural diagram of a wireless data terminal in another specific embodiment of the present disclosure, where a mainboard is connected to a second antenna.

FIG. 18 is a schematic structural diagram of a wireless data terminal in yet another specific embodiment of the present disclosure, where a mainboard is connected to a second antenna.

FIG. 19 is a schematic structural diagram of a wireless data terminal in still yet another specific embodiment of the present disclosure, where a mainboard is connected to a second antenna.

### REFERENCE NUMERALS

1—First main body: 11—Mainboard: 111—First antenna: 111a—First connection portion: 112—Battery: 113—Power receiving coil: 12—Third housing: 121—Front housing: 121a—Screen: 122—Rear housing: 122a—Fourth through hole; 123—Battery compartment: 124—Charging port:
2—Second main body: 21—First support member: 211—First housing: 211a—First cavity: 211b—First through hole: 211c—Support surface: 212—Support rib: 213-Rotation shaft: 214—Second connection portion: 215—Second plug: 217—Charging coil: 218—Boss: 22—Second support member; 221—Second housing; 221a-Second cavity: 221b—Second through hole; 221c—Third through hole: 221d-First plug: 221e—Foot pad: 221f—Blocking member: 23—Second antenna: 24—Heat dissipation member: 241—First gas inlet: 242—Second gas inlet: 243—Gas outlet: 25—Circuit board: 251—Cable: 252—Coil FPC: 26—Foam; 27—Gas duct: 28—Cooling fin: 29—heat conductive pad.

The accompanying drawings herein, which are incorporated into this specification and constitute a part of this specification, illustrate embodiments consistent with the present disclosure, and are used for explaining the principles of the present disclosure together with this specification.

### DESCRIPTION OF EMBODIMENTS

In order to better understand the technical solutions of the present disclosure, the embodiments of the present disclosure are described in detail below with reference to the accompanying drawings.

It should be noted that the described embodiments are merely some rather than all embodiments of the present disclosure. All other embodiments obtained by persons of ordinary skill in the art based on embodiments of the present disclosure without creative effort belong to the protection scope of the present disclosure.

Terms used in the embodiments of the present disclosure are merely used for the purpose of describing particular embodiments and are not intended to limit the present disclosure. Singular forms “a/an”, “the/said” and “this” used in the embodiments and the append claims of the present disclosure are intended to include plural forms, unless the context clearly indicates otherwise.

It should be understood that the term “and/or” used herein merely is describing an association relationship of associated objects, indicating that three relationships may exist, for example, A and/or B may indicate that A exists alone, A and B exist simultaneously, and B exists alone. In addition, the character “/” herein generally indicates that the associated objects before and after the character are in an “or” relationship.

It should be noted that directional words such as “above/on”, “below”, “left”, “right”, etc., described in the embodiments of the present disclosure are described in terms of orientations shown in the accompanying drawings, and should not be understood to limit the embodiments of the present disclosure. In addition, in context, it should be understood that when referring to an element being connected “above/on” or “below” another element, such element can not only be directly connected “above/on” or “below” another element, but also be indirectly connected “above/on” or “below” another element through an intermediate element.

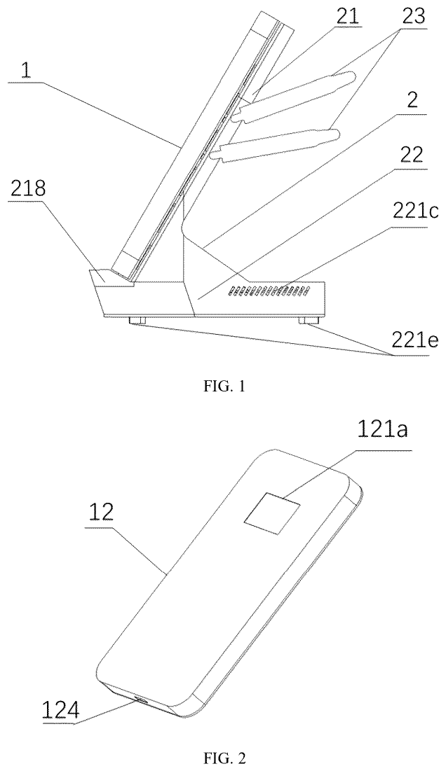

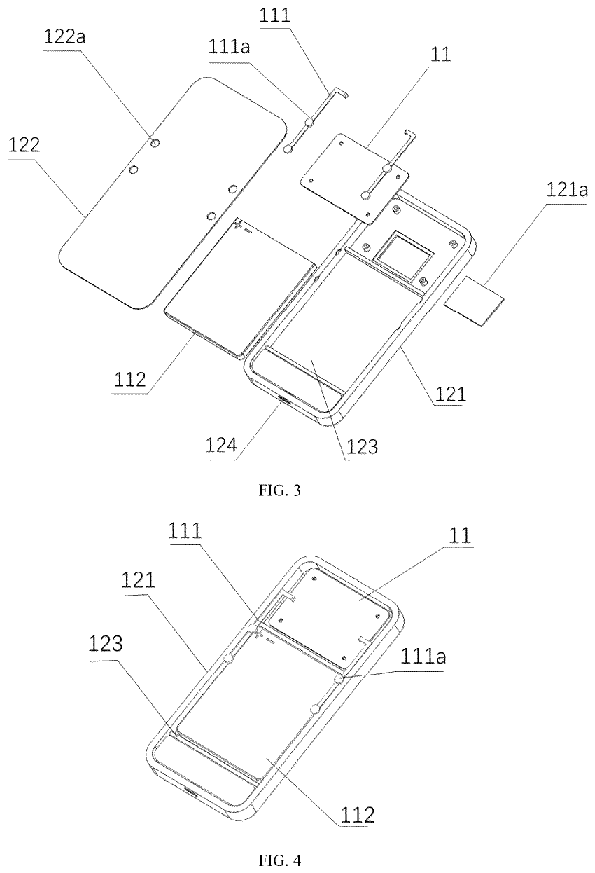

The embodiments of the present disclosure provide a wireless data terminal. As shown in FIG. 1, the wireless data terminal includes a first main body 1 and a second main body 2. As shown in FIG. 3 and FIG. 4, the first main body 1 includes a mainboard 11 and a first antenna 111, and the mainboard 11 is used for converting a 3G/4G/5G cellular signal into a WiFi signal. The first antenna 111 in a working state is used for transmitting and receiving a cellular signal and a WiFi signal for users to use. The second main body 2 includes a second antenna 23, and the second antenna 23 in a working state is used for receiving and transmitting a cellular signal and a WiFi signal for users to use. The second antenna 23 of the second main body 2 can be connected to or disconnected from the mainboard 11 of the first main body 1. When the second antenna 23 is not connected to the mainboard 11, the second antenna 23 is not in a working state, and only the first antenna 111 is used for receiving and transmitting a cellular signal and a WiFi signal. When the second antenna 23 is connected to the mainboard 11, the second antenna 23 is in a working state, and at this time, the first antenna 111 and the second antenna 23 are used for transmitting and receiving a cellular signal and a WiFi signal, or only the second antenna 23 is used for transmitting and receiving a cellular signal and a WiFi signal. The connection between the mainboard 11 and the second antenna 23 may be an electrical connection or a signal connection, that is, when the mainboard 11 is connected to the second antenna 23, a cellular signal and a WiFi signal transmitted and received by the second antenna 23 can be transmitted to the mainboard 11, and the mainboard 11 can also be used to control the working state of the second antenna 23.

In the embodiments of the present disclosure, when the mainboard 11 is not connected to the second antenna 23, the first antenna 111 of the first main body 1 can receive and transmit a cellular signal and a WiFi signal, and the first main body 1 is small in size and convenient to carry, and can be used as a portable WiFi for allowing various terminal devices, such as mobile phone, tablet and computer, to access thereto. When the mainboard 11 is connected to the second antenna 23, the second antenna 23 is in a working state, that is, the second main body 2 can provide the first main body 1 with a high-performance antenna (the second antenna 23), so that the WiFi signal is strong and fast, thereby meeting the requirement for high-performance WiFi at home.

Therefore, the wireless data terminal in the embodiments of the present disclosure has the advantages of portability and high performance WiFi, so that the user experience and applicability of the wireless data terminal are high.

In addition, when the mainboard 11 is connected to the second antenna 23, a mechanical connection may or may not exist between the first main body 1 and the second main body 2. For example, when no mechanical connection exists between the first main body 1 and the second main body 2, as shown in FIG. 17, it is only necessary to connect the mainboard 11 of the first main body 1 to the second antenna 23 of the second main body 2 by a wire. When a mechanical connection exists between the first main body 1 and the second main body 2, as shown in FIG. 18, the first main body 1 may be connected with the second main body 2 in a manner of plug-in connection, snap-in connection, or the like, in addition to that the mainboard 11 of the first main body 1 is in an electrical connection or a signal connection with the second antenna 23 of the second main body 2. When a mechanical connection exists between the first main body 1 and the second main body 2, as shown in FIG. 1, the first main body I can be placed on the second main body 2 so as to support the first main body 1 through the second main body 2. Therefore, in the present disclosure, whether there is a mechanical connection between the first main body 1 and the second main body 2 and how to connect the two are not limited.

In a specific embodiment, as shown in FIGS. 2 to 4, the first main body 1 further includes a third housing 12 and a battery 112. The battery 112 is used for supplying power to the mainboard 11, so that the mainboard 11 can still work when the first main body 1 is in an out-of-home mode, thereby improving the portability of the first main body 1. The mainboard 11, the first antenna 111, and the battery 112 are all located in an inner cavity of the third housing 12, and the first antenna 111 is located on both sides of the mainboard 11 along a width direction. The third housing 12 may specifically include a front housing 121 and a rear housing 122, and the front housing 121 and the rear housing 122 enclose to form a cavity for accommodating the mainboard 11, the first antenna 111, and the battery 112.

Specifically, a battery compartment 123 is formed in the inner cavity of the third housing 12, and the battery compartment 123 is used to accommodate the battery 112. In the embodiments shown in FIGS. 2 to 4, the mainboard 11 and the battery 112 are disposed side by side up and down along a length direction of the first main body 1, or the mainboard 11 and the battery 112 may be disposed along a thickness direction of the first main body 1, that is, the mainboard 11 is located at a side close to the front housing 121, and the battery 112 is located at a side close to the rear housing 122. In addition, the front housing 121 of the third housing 12 may further be provided with a screen 121a, and the screen 121a may be used to display information such as a power level of the battery 112, a signal strength, and the number of accessed devices.

In the embodiments of the present disclosure, when the mainboard 11 of the first main body 1 is not connected to the second antenna 23 of the second main body 2, for example, when the first main body 1 is in an out-of-home mode, the first antenna 111 works and a cellular signal and a WiFi signal are received and transmitted through the first antenna 111. When the mainboard 11 of the first main body 1 is connected to the second antenna 23 of the second main body 2, for example, when the first main body 1 is in at-home mode, the mainboard 11 is connected to the second antenna 23 through a conductive member, so that the mainboard 11 can conduct signals with the second antenna 23. At this time, the second antenna 23 can also receive and transmit a cellular signal and a WiFi signal, thereby meeting the requirement for the network performance of the wireless data terminal due to good performance of the second antenna 23.

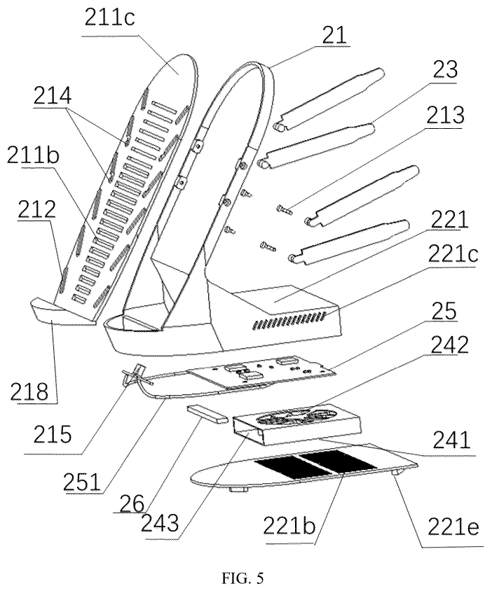

Specifically, as shown in FIG. 3, the mainboard 11 is provided with a first connection portion 111a, the first main body 1 includes a third housing 12 provided with a fourth through hole 122a. The first connection portion 111a is exposed through the fourth through hole 122a. Correspondingly, as shown in FIG. 5, the first support member 21 includes a first housing 211 provided with a second connection portion 214, and the second connection portion 214 is connected to the second antenna 23. The second connection portion 214 and the second antenna 23 may be connected through a wire, and may also be connected through a metal wire, an FPC, or the like. The first connection portion 111a and the second connection portion 214 are made of metal. When the mainboard 11 of the first main body 1 is connected to the second antenna 23 of the second main body 2, that is, when the first main body 1 is in at-home mode, the first connection portion 111a is in contact with the second connection portion 214, so that the first main body 1 is connected to the second antenna 23 through conductive members (the first connection portion 111a, the second connection portion 214, and wire, etc.), so as to realize a signal conduction between the mainboard 11 and the second antenna 23.

In this embodiment, when the mainboard 11 of the first main body 1 is not connected to the second antenna 23 of the second main body 2, that is, when the first main body 1 is in the out-of-home mode, the wireless data terminal transmits a signal through the first antenna 111. When the mainboard 11 of the first main body 1 is connected to the second antenna 23 of the second main body 2, that is, when the first main body 1 is in at-home mode, the wireless data terminal may receive and transmit a signal through the first antenna 111 and the second antenna 23, or may receive and transmit a signal only through the second antenna 23, that is, when the mainboard 11 of the first main body 1 is connected to the second antenna 23 of the second main body 2, the first antenna 111 may not work.

The first connection portion 111a may be disposed on the mainboard 11. In the embodiment shown in FIG. 3, the first connection portion 111a is disposed on the first antenna 111. Since the first antenna 111 is connected to the mainboard 11, the first connection portion 111a is connected to the mainboard 11 through the first antenna 111.

More specifically, at least a portion of the first connection portion 111a is located in the fourth through hole 122a, so that the first connection portion 111a and the fourth through hole 122a form a groove. As shown in FIG. 5, the second connection portion 214 protrudes with respect to a support surface 211c of the first support member 21. When the mainboard 11 of the first main body 1 is connected to the second antenna 23 of the second main body 2, at least a portion of the second connection portion 214 can be located in the groove formed by the fourth through hole 122a and the first connection portion 111a and is in contact with the first connection portion 111a so as to realize a signal conduction between the first main body 1 and the second antenna 23. Meanwhile, when the second connection portion 214 extends into the fourth through hole 122a, a snap-fit between the first main body 1 and the first support member 21 can be realized by concave-convex cooperation between the second connection portion 214 and the fourth through hole 122a, so as to prevent the first main body 1 from falling off from the second main body 2. Therefore, the first connection portion 111a, the fourth through hole 122a and the second connection portion 214 in this embodiment can not only realize a signal conduction between the first main body 1 and the second antenna 23, but also realize a mechanical connection between the first main body 1 and the second main body 2.

In this embodiment, the wireless performance of the first main body 1 is affected by temperatures of respective components in the first main body 1 in addition to the antenna performance. That is, when the temperatures of respective components in the first main body I are too high, the number of devices that can be accessed by the first main body 1, WiFi signal strength, and wireless network rate are all limited. At this time, the first main body I can meet the requirement for accessing a small number of devices when going out, but cannot meet the requirement for a high-performance network at home.

In order to solve this technical problem, as shown in FIG. 5, the second main body 2 is further provided with a heat dissipation member 24. The mainboard 11 of the first main body 1 is connected to the second antenna 23 of the second main body 2, that is, when the first main body 1 is in at-home mode, the heat dissipation member 24 is used to dissipate heat from the first main body 1, thereby reducing temperatures of respective components in the first main body 1, thus improving the performance of the wireless data terminal, increasing the number of devices that can be accessed, enhancing WiFi signal, accelerating the wireless network rate, and meeting the use demand of the first main body 1. In addition, when the heat dissipation member 24 is provided on the second main body 2, there is no need to provide a heat dissipation member in the first main body 1, which reduces the weight and volume of the first main body 1, so that the first main body 1 has high portability when the mainboard 11 is not connected to the second antenna 23 (e.g., in an out-of-home mode).

Specifically, the heat dissipation member 24 may be a cooling fan. Alternatively, the heat dissipation member 24 may be other components, such as a liquid cooling radiator, a thermoelectric cooler, etc.

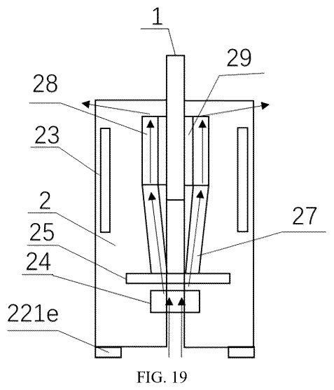

Specifically, as shown in FIG. 9 and FIG. 19, a gas duct 27 is provided in the interior of the second main body 2, and gas out of the heat dissipation member 24 can enter the gas duct 27. A first through hole 211b is provided on a side of the second main body 2 in connection with the first main body 1, and the first through hole 211b is in communication with the gas duct 27.

When the mainboard 11 of the first main body 1 is connected to the second antenna 23 of the second main body 2, gas out of the heat dissipation member 24 can be blown to the mainboard 11 and other component of the first main body 1 through the gas duct 27 and the first through hole 211b (gas direction is shown by arrows in FIG. 9 and FIG. 19), thereby dissipating heat from the mainboard 11 and other components. In this embodiment, the specific structure of the second main body 2 is not limited as long as the gas duct 27 is provided therein.

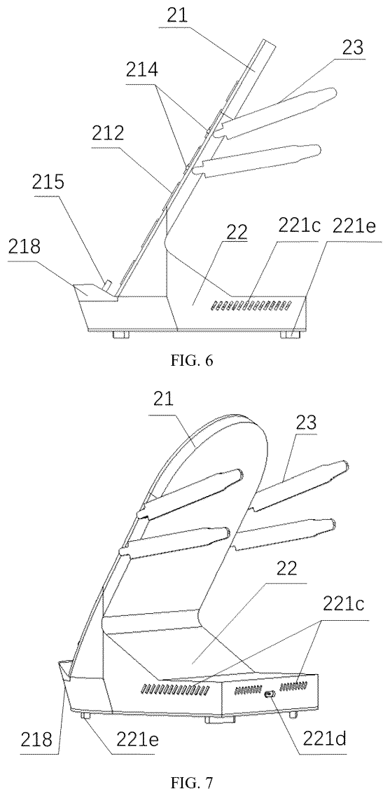

In a specific embodiment, as shown in FIG. 5 and FIG. 6, the second main body 2 includes a first support member 21 and a second support member 22 which are connected with each other. The above second antenna 23 is disposed on the first support member 21. When the mainboard 11 is connected to the second antenna 23, the first main body I can be placed on the first support member 21, and the second support member 22 can be supported on a desktop or a floor so as to place the first main body 1 through the second main body 2.

The second antenna 23 is rotatably connected to the first support member 21 through a rotation shaft 213. That is, the second antenna 23 can rotate with respect to the first support member 21 and the first main body 1, so as to facilitate transmitting and receiving of signal, thereby further improving the network performance of the wireless data terminal.

Referring to FIG. 9, the first support member 21 includes a first housing 211 with a first cavity 211a. The first housing 211 has a support surface 211c, which is used for placing the first main body 1 and is provided with a first through hole 211b, and the first through hole 211b is communicated with the first cavity 211a. In a specific embodiment, the above heat dissipation member 24 is located in the first cavity 211a, and at this time, the first cavity 211a is the above gas duct 27.

In this embodiment, when the mainboard 11 of the first main body 1 is connected to the second antenna 23 of the second main body 2, for example, when the first main body 1 is in at-home mode, since the first support member 21 of the second main body 2 is used to support the first main body 1, a distance between the heat dissipation member 24 and the first main body 1 is relatively small when the heat dissipation member 24 is installed in the first cavity 211a of the first support member 21, so that cold gas out of a gas outlet 243 of the heat dissipation member 24 can be blown to the first main body 1 through the first through hole 211b, thereby rapidly cooling the components of the first main body 1, achieving rapid cooling of the first main body 1, and improving the network performance of the first main body 1.

In another specific embodiment, as shown in FIG. 5 and FIG. 9, the second support member 22 of the second main body 2 includes a second housing 221 with a second cavity 221a. The first through hole 211b is communicated with the first cavity 211a and the second cavity 221a, and the heat dissipation member 24 is located in the second cavity 221a. At this time, the first cavity 211a and the second cavity 221a communicating with each other are the above gas duct 27.

In this embodiment, the flow path of cold gas out of the gas outlet 243 of the heat dissipation member 24 within the cavity of the second main body 2 is as shown by arrows in FIG. 9. That is, cold gas is discharged from the gas outlet 243 to the second cavity 221a, flows from the second cavity 221a to the first cavity 211a communicated therewith, and finally flows out through the first through hole 211b communicated with the first cavity 211a and is blown to the first main body 1, thereby playing a role in cooling the components in the first main body 1. When the heat dissipation member 24 is provided in the second cavity 221a of the second support member 22, since the second support member 22 is used for being supported on a desktop or a floor, the heat dissipation member 24 is more convenient to be provided in the inner cavity of the second support member 22.

The first through hole 211b of the first housing 211 may be an elongated hole or a through hole in other shapes. A plurality of first through holes 211b are disposed on the support surface 211c of the first housing 211 at intervals. When the first main body 1 works, the mainboard 11 generates a lot of heat, and at this time, a range of the plurality of first through holes 211b at least covers the mainboard 11 of the first main body 1, so that cold gas discharged from the heat dissipation member 24 can be blown to the mainboard 11 to cool the mainboard 11, thereby enhancing the performance of the mainboard 11, and further improving the network performance of the wireless data terminal.

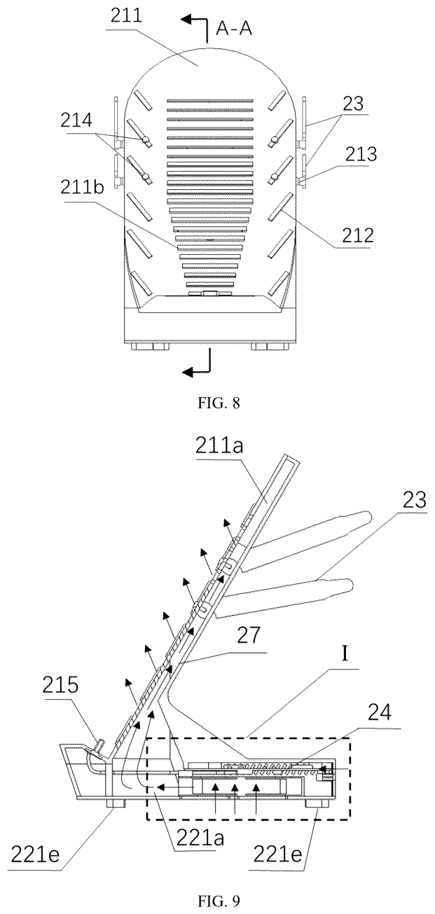

Of course, in the embodiment shown in FIG. 8, the range of the plurality of first through holes 211b may cover the battery 112 in addition to covering the mainboard 11. When the first main body 1 is placed on the second main body 2, a distance between the battery 112 and the heat dissipation member 24 is smaller than a distance between the mainboard 11 and the heat dissipation member 24. That is, cold gas discharged from the gas outlet 243 of the heat dissipation member 24 first passes through the battery 112 and then passes through the mainboard 11, that is, a flow rate of cold gas passing through the mainboard 11 is lower than that of cold gas passing through the battery 112. At this time, a cross-sectional area of the first through hole 211b corresponding to the battery 112 is smaller than that of the first through hole 211b corresponding to the mainboard 11, so that a large amount of cold gas is prevented from being discharged from the first through hole 211b corresponding to the battery 112 and failing to effectively cool the mainboard 11, thereby ensuring the heat dissipation efficiency of the heat dissipation member 24 to the mainboard 11.

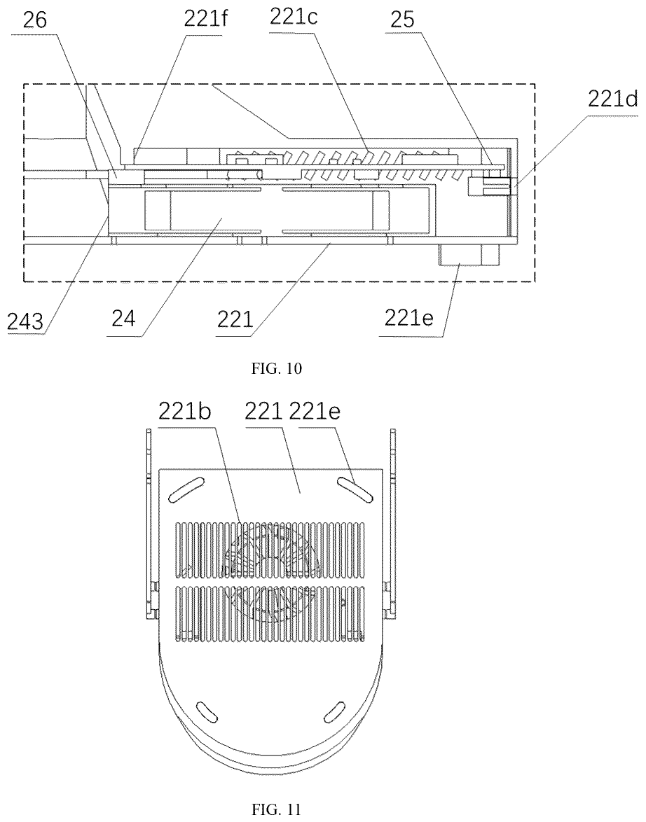

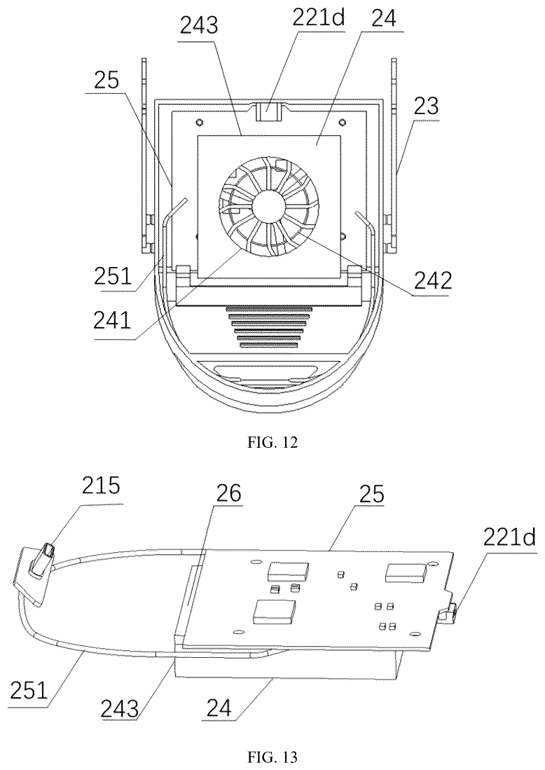

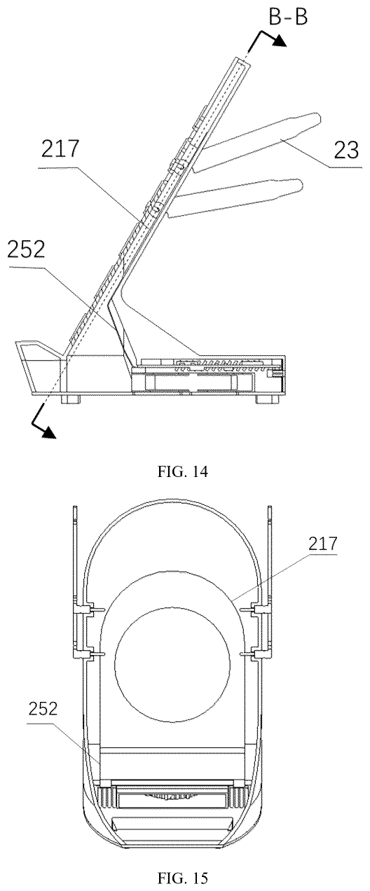

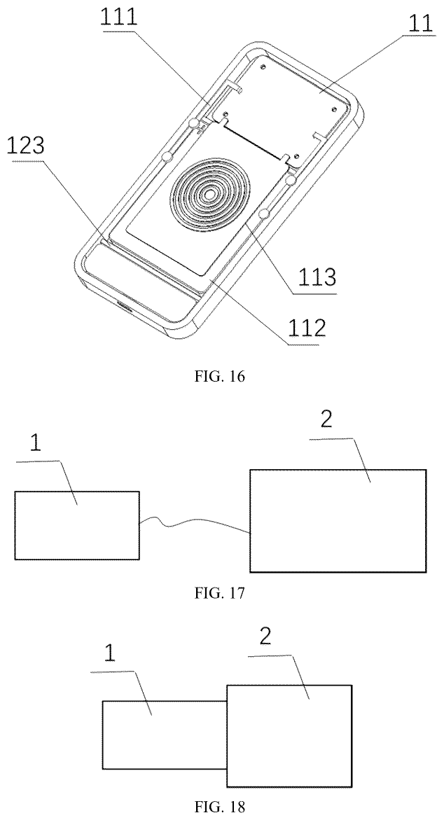

More specifically, as shown in FIG. 9 and FIG. 10, the heat dissipation member 24 has a gas outlet 243 and at least one gas inlet. The gas outlet 243 is communicated with the first cavity 211a. A blocking member 221f is provided in the second housing 221, and the blocking member 221f is used to separate the gas outlet 243 from the gas inlet, so that the blocking member 221f separates an outgoing gas flow from an incoming gas flow of the heat dissipation member 24, thereby preventing the gas outlet 243 of the heat dissipation member 24 from flowing back, and improving the heat dissipating efficiency of the heat dissipation member 24.

The blocking member 221f may be a blocking wall provided in the second cavity 221a, and the blocking wall may be fixedly connected to or integrally formed with the second housing 221, so as to separate the gas outlet 243 from respective gas inlets. Alternatively, the blocking member 221f may be, for example, a foam 26 provided in the second cavity 221a, and the foam 26 is located at an edge of the heat dissipation member 24 close to the gas outlet 243. In this case, the foam 26 can play a role in separating an outgoing gas flow from an incoming gas flow. Specifically, the foam 26 is placed at a predetermined position by bonding or the like, thereby separating the gas outlet 243 from respective gas inlets.

In the above various embodiments, as shown in FIG. 5, the wireless data terminal further includes a circuit board 25 located in the second cavity 221a, and the circuit board 25 can be electrically connected to a power supply so as to supply power to the heat dissipation member 24.

As shown in FIG. 7, the second main body 2 has a first plug 221d. The first plug 221d is electrically connected with the circuit board 25, and is used for electrically connection with an external power supply. After the first plug 221d is electrically connected with the external power supply, the heat dissipation member 24 can work. In this case, when the mainboard 11 determines that the mainboard 11 of the first main body 1 is connected to the second antenna 23 of the second main body 2, the mainboard 11 controls the heat dissipation member 24 to start working, so as to dissipate heat from respective components of the first main body 1. When the mainboard 11 determines that the mainboard 11 of the first main body 1 is not connected to the second antenna 23 of the second main body 2, the heat dissipation member 24 cannot work even if the circuit board 25 supplies power to the heat dissipation member 24, so as to avoid energy waste caused by the operation of the heat dissipation member 24 when the mainboard 11 is not connected to the second antenna 23.

Specifically, as shown in FIG. 13, a foam 26 is disposed between the circuit board 25 and the heat dissipation member 24, and the foam 26 is a flexible material, so that the circuit board 25 is in flexible contact with the heat dissipation member 24 to prevent the circuit board 25 from being damaged. In addition, the blocking wall disposed in the second housing 221 of the second support member 22 together with the foam 26 play a role of separating the gas outlet 243 of the heat dissipation member 24 from respective gas inlets. That is, the blocking member 221f may include the foam 26.

In addition, when the mainboard 11 is connected to the second antenna 23, that is, when the first main body 1 is placed on the second main body 2, the circuit board 25 is electrically connected to the battery 112, so that the circuit board 25 can not only supply power to the heat dissipation member 24, but also charge the battery 112. Therefore, the battery 112 can be charged through the circuit board 25 when the mainboard 11 is connected to the second antenna 23, so that when the mainboard 11 is not connected to the second antenna 23, the charged battery 112 can supply power to the mainboard 11 and thus the first main body I can be used normally.

In a specific embodiment, as shown in FIG. 3, the bottom of the first main body 1 is provided with a charging port 124, and the charging port 124 is electrically connected to the battery 112. Correspondingly, as shown in FIG. 5, the second main body 2 is provided with a second plug 215, and the second plug 215 is electrically connected to the circuit board 25 through a cable 251. When the mainboard 11 is connected to the second antenna 23, the second plug 215 disposed on the second main body 2 can be electrically connected to the charging port 124 at the bottom of the first main body 1, so that the battery 112 is electrically connected to the circuit board 25, and the battery 112 is charged through the circuit board 25. In this embodiment, the electrical connection of the second plug 215 to the charging port 124 realizes a wired charging of the battery 112, thereby saving cost.

In another specific embodiment, as shown in FIG. 15, a charging coil 217 electrically connected to the circuit board 25 is provided in the first cavity 211a of the second support member 22. The circuit board 25 is electrically connected to the charging coil 217 through a coil FPC252. A power receiving coil 113 electrically connected to the battery 112 is provided in the third housing 12 of the first main body 1. When the mainboard 11 is connected to the second antenna 23, that is, when the first main body 1 is placed on the first support member 21 of the second main body 2, the charging coil 217 is close to the power receiving coil 113, so that a current is generated by electromagnetic induction between the charging coil 217 and the power receiving coil 113 to charge the battery 112. In this embodiment, the charging coil 217 and the power receiving coil 113 can realize a wireless charging of the battery 112, thereby simplifying the structure of the wireless data terminal.

Specifically, as shown in FIG. 9 and FIG. 11, the bottom of the second housing 221 is provided with a second through hole 221b. As shown in FIG. 7, a side of the second housing 221 is provided with a third through hole 221c. Meanwhile, the heat dissipation member 24 has a first gas inlet 241 facing the bottom of the second support member 22 and a second gas inlet 242 facing the circuit board 25. At this time, the second through hole 221b at the bottom of the second housing 221 faces the first gas inlet 241, and the third through hole 221c at the side of the second housing 221 is closer to the second gas inlet 242, so that gas can enter the heat dissipation member 24 through the second through hole 221b and the third through hole 221c. Meanwhile, the circuit board 25 is located within a projection range of the third through hole 221c, so that cold gas entering the heat dissipation member 24 through the second gas inlet 242 can pass through the circuit board 25 to dissipate heat from the circuit board 25.

As shown in FIG. 7, in addition to a side surface of the second housing 221 connected to the first support member 21, other side surfaces of the second housing 221 are all provided with the third through hole 221c. As shown in FIG. 11, the second through hole 221b at the bottom of the second housing 221 may be specifically a plurality of elongated holes or a plurality of holes in other shapes, and the projection of the second through hole 221b at least covers the first gas inlet 241 of the heat dissipation member 24, so that gas can effectively enter the heat dissipation member 24. Meanwhile, the bottom of the second housing 221 is further provided with a foot pad 221e, so that there is a gap between the second housing 221 and the ground to allow a gas flow of the heat dissipation member 24 to pass therethrough.

In the above embodiments, as shown in FIG. 6, the first support member 21 of the second main body 2 is inclined upward with respect to the second support member 22, and the first support member 21 has a support surface 211c for supporting the first main body 1. An included angle between the support surface 211c and the second support member 22 is an acute angle. In this embodiment, when the mainboard 11 is connected to the second antenna 23, as shown in FIG. 1, the first main body 1 is placed obliquely with respect to the ground, which is convenient for users to check the working state of the first main body 1 at any time, and the first support member 21 disposed obliquely can also provide an enough rotating space for the second antenna 23, so as to better receive signals, thereby further improving the network performance of the wireless data terminal.

The acute angle a between the support surface 211c of the first support member 21 and the second support member 22 may specifically be 20°≤α≤80°. The first support member 21 and the second support member 22 may be fixedly connected with each other or integrally formed.

Specifically, as shown in FIG. 5 and FIG. 6, the second main body 2 further includes a boss 218 protruded relative to the support surface 211c. The boss 218 is located at one end of the first support member 21 connected to the second support member 22, and the boss 218 is substantially perpendicular to the support surface 211c, so that the boss 218 and the support surface 211c are spliced to form a space for placing the first main body 1. When the mainboard 11 is connected to the second antenna 23, the first main body I can be placed on the support surface 211c and abut against the boss 218.

In this embodiment, the boss 218 can play a role in limiting the first main body 1, thereby preventing the first main body 1 from falling off the second main body 2.

The boss 218 may be provided on the first support member 21 or the second support member 22, or integrally formed with the first support member 21 and the second support member 22, as long as the boss 218 can protrude relative to the support surface 211c.

More specifically, when the first main body 1 is placed on the second main body 2, the third housing 12 of the first main body 1 may be detachably connected to the first housing 211 of the first support member 21 in addition to that the first main body 1 abuts against the boss 218, so as to further install the first main body 1 to the second main body 2, to improve the connection reliability between the first main body 1 and the second main body 2, and thus to improve the reliability of the electrical connection between components within the first main body 1 and the second main body 2, i.e., improving the reliability of the electrical connection between the second plug 215 and the charging port 124 of the first main body 1, and enabling a cooling gas discharged from the heat dissipation member 24 to dissipate heat from components of the first main body 1.

Further, as shown in FIG. 8, the support surface 211c is provided with a plurality of support ribs 212. When the mainboard 11 is connected to the second antenna 23, the first main body I can be placed on the support ribs 212, so that there is a gap between the first main body 1 and the support surface 211c, which makes that there is a gap between the bottom surface of the first main body 1 and the first through hole 211b of the first support member 21, so that the gas out of the heat dissipation member 24 can be blown to the first main body 1 through the first through hole 211b, thereby improving the heat dissipating efficiency and enabling the wireless data terminal to have good network performance.

In a specific embodiment, as shown in FIG. 8, the second connection portion 214 is disposed on the support rib 212. At this time, it is convenient to enable the second connection portion 214 to extend into the fourth through hole 122a of the first main body 1.

In another specific embodiment, as shown in FIG. 19, the heat dissipation member 24 is provided in the inner cavity of a base, and the second main body 2 is further provided with a gas duct 27. When the mainboard 11 of the first main body 1 is connected to the second antenna 23 of the second main body 2, the gas out of the heat dissipation member 24 can be blown to the mainboard 11 and other component of the first main body 1 through the gas duct 27 (gas direction is shown by the arrow in FIG. 19), thereby dissipating heat from the components such as the mainboard 11. Meanwhile, the second main body 2 may further include a cooling fin 28. The cooling fin 28 is located at a position of the second main body 2 in connection with the first main body 1, and the cooling fin 28 corresponds to the gas duct 27. When the first main body 1 is connected to the second main body 2, the cooling fin 28 is in contact with the first main body 1, so that the gas out of the heat dissipation member 24 can be blown to the cooling fin 28, thereby dissipating heat from respective components in the first main body 1. At this time, the cooling fin 28 is combined with the heat dissipation member 24, so that the heat dissipation efficiency to respective components in the first main body I can be improved.

In this embodiment, as shown in FIG. 19, in the second main body 2, the circuit board 25 is located at the downstream of the gas outlet of the heat dissipation member 24, so that the gas out of the heat dissipation member 24 can be blown to the circuit board 25 to dissipate heat from the circuit board 25. Meanwhile, the circuit board 25 is provided with a plurality of through holes communicated with the gas duct 27, so that the gas out of the heat dissipation member 24 can enter the gas duct 27 through the through holes of the circuit board 25.

In addition, the second main body 2 may further include a heat conductive pad 29. The heat conductive pad 29 is disposed at a position where the second main body 2 is connected to the first main body 1, and is a flexible material. When the first main body 1 is connected to the second main body 2, the heat conductive pad 29 is in contact with the first main body 1 to reduce an impact between the first main body 1 and the second main body 2. The heat conductive pad 29 can conduct heat from the first main body 1 to the cooling fin 28 of the second main body 2 so as to further improve the heat dissipation efficiency.

The above embodiments are merely some embodiments of the present disclosure and are not intended to limit the present disclosure. Various modifications and variations can be made to the present disclosure by those skilled in the art. Any modifications, equivalent substitutions, improvements, etc. made within the spirit and principles of the present disclosure shall be included in the protection scope of the present disclosure.

1. A wireless data terminal, comprising:
a first main body, which comprises a mainboard, the mainboard being provided with a first antenna; and
a second main body, which is provided with a second antenna;
wherein in case that the second antenna of being connected to the mainboard, at least the second antenna is used for receiving and transmitting a cellular signal and a WiFi signal; and in case that the second antenna is disconnected from the mainboard, the first antenna is used for receiving and transmitting a cellular signal and a WiFi signal.

2. The wireless data terminal according to claim 1, wherein the first main body and the second main body are plugged into each other so as to make the second antenna to be connected to the mainboard; or, the first main body is connected to the second main body through a wire so as to make the second antenna to be connected to the mainboard; or, the first main body is placed on the second main body so as to make the second antenna to be connected to the mainboard .

3. The wireless data terminal according to claim 1, wherein the second main body is further provided with a heat dissipation member, and in case that the second antenna is connected to the mainboard, the heat dissipation member is used for dissipating heat from the first main body.

4. The wireless data terminal according to claim 3, wherein a gas duct is provided within the second main body, and gas out of the heat dissipation member enters the gas duct; and
a first through hole is provided on a side of the second main body in connection with the first main body, and the first through hole is in communication with the gas duct.

5. The wireless data terminal according to claim 4, wherein the second main body comprises a first support member and a second support member, which are connected with each other, and the second antenna is disposed on the first support member; and
the first main body is placed on the first support member.

6. The wireless data terminal according to claim 5, wherein the first support member comprises a first housing with a first cavity, the first housing has a support surface, which is used for placing the first main body and is provided with the first through hole, and the first cavity is the gas duct; and
the heat dissipation member is located inside the first cavity.

7. The wireless data terminal according to claim 5, wherein the first support member comprises a first housing with a first cavity, the first housing has a support surface, which is used for placing the first main body and is provided with the first through hole, and the first through hole is communicated with the first cavity;
the second support member comprises a second housing with a second cavity, and the first cavity and the second cavity which are communicated with each other form the gas duct; and
the heat dissipation member is located inside the second cavity.

8. The wireless data terminal according to claim 7, wherein the heat dissipation member has a gas outlet and at least one gas inlet, and the gas outlet is communicated with the first cavity; and
a blocking member is disposed inside the second cavity.

9. The wireless data terminal according to claim 7, wherein the wireless data terminal further comprises a circuit board located inside the second cavity, and in case that the circuit board is connected to a power supply, the circuit board to supplies power to the heat dissipation member.

10. The wireless data terminal according to claim 9, wherein a bottom of the second housing is provided with a second through hole, and a side of the second housing is provided with a third through hole; and
a first gas inlet of the heat dissipation member faces the second through hole, a second gas inlet of the heat dissipation member faces the circuit board, and the circuit board is located within a projection region of the third through hole.

11. The wireless data terminal according to claim 9, wherein a foam is disposed between the circuit board and the heat dissipation member; and
the foam is located at an edge of the heat dissipation member close to a gas outlet of the heat dissipation member.

12. The wireless data terminal according to claim 9, wherein the first main body further comprises a battery electrically connected to the mainboard, and in case that the second antenna is connected to the mainboard, the circuit board is electrically connected to the battery so as to make the circuit board to charge the battery.

13. The wireless data terminal according to claim 12, wherein the battery is connected to the circuit board through a cable; or,
a charging coil electrically connected to the circuit board is disposed inside the first cavity, the first main body is provided with a power receiving coil electrically connected to the battery, and the battery is charged through the charging coil and the power receiving coil.

14. The wireless data terminal according to claim 1, wherein the second antenna is connected to the mainboard through a conductive member.

15. The wireless data terminal according to claim 14, wherein the mainboard is provided with a first connection portion, the first main body comprises a third housing, the third housing is provided with a fourth through hole, and the first connection portion is exposed through the fourth through hole;
the second main body comprises a first support member and a second support member which are connected with each other, the first support member comprises a first housing, the first housing is provided with a second connection portion, and the second connection portion is connected to the second antenna; and
the first connection portion and the second connection portion are electrically conductive and in contact with each other so as to make the mainboard to be connected with the second antenna through the conductive member.

16. The wireless data terminal according to claim 15, wherein at least a portion of the first connection portion is located within the fourth through hole; and
the second connection portion protrudes relative to a support surface of the first support member, and at least a portion of the second connection portion is located in the fourth through hole and in contact with the first connection portion.

17. The wireless data terminal according to claim 16, wherein the support surface is provided with a plurality of support ribs, and the first main body is placed on the support ribs so as to have a gap between the first main body and the support surface.

18. The wireless data terminal according to claim 17, wherein the second connection portion is disposed on the support rib.

19. The wireless data terminal according to claim 1, wherein the second main body comprises a first support member and a second support member which are connected with each other, the first support member is inclined upwards with respect to the second support member, and the first support member has a support surface for supporting the first main body; and
an included angle between the support surface and the second support member is an acute angle.

20. The wireless data terminal according to claim 19, wherein the second main body further comprises a boss raised with respect to the support surface, and the first main body is placed on the support surface and abuts against the boss.
